(19) United States
(12) Patent Application Publication
(10) Pub. No.: US 2019/0295189 A1
(43) Pub. Date: Sep. 26, 2019

(54) Automobile Identification and Variable Rate Fuel System and Method

(71) Applicant: Itron, Inc., Liberty Lake, WA (US)

(72) Inventor: Robert Strasser, Spokane, WA (US)

(21) Appl. No.: 16/024,305

(22) Filed: Jun. 29, 2018

Related U.S. Application Data
(60) Provisional application No. 62/647,506, filed on Mar. 23, 2018.

(51) Int. Cl. G06Q 50/06; G06Q 20/20; G06Q 20/42; G06Q 20/40; G06Q 20/32; G06Q 20/18; B67D 7/14

(52) U.S. Cl. CPC G06Q 50/06; G06Q 20/201; G06Q 20/42; B67D 2007/0442; G06Q 20/3278; G06Q 20/18; B67D 7/145; G06Q 20/405

(57) ABSTRACT

Techniques for vehicle identification are described herein. In one example, vehicle identification information is obtained for a vehicle at a smart fueling station. Using the vehicle identification information, characteristics of the vehicle may be considered, and a fuel price can be set. Fuel can be dispensed to the vehicle according to the price as set. Payment may be made, such as by an automated system based on near field communications (NFC). The techniques used to identify the vehicle may utilize connections to the on-board diagnostic port (e.g., OBD II) of the vehicle, NFC and data encryption techniques.

### BACKGROUND

Large quantities of gasoline are used by vehicles. Gasoline use is an expense for the economy, problematic for foreign policy, and a detriment to the environment.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is diagram showing an example system configured to identify a vehicle and to set a fuel price.

FIG. 2 is diagram showing an example of a device configured for attachment to an on-board diagnostics port (e.g., OBD II).

FIG. 3 is diagram showing an example of a fuel price-determination device.

FIG. 4 is diagram showing an example of a smartphone configured for vehicle identification and variable rate fuel.

FIG. 5 is a flow diagram showing example operation of a smart fueling station in a smart fueling system.

FIG. 6 is a flow diagram showing example details by which a smart fueling station can obtain vehicle identification information.

FIG. 7 is a flow diagram showing example techniques by which a smart fueling station can obtain price information specific to the vehicle.

FIG. 8 is a flow diagram showing example operation of a smart vehicle in a smart fueling system.

FIG. 9 is a flow diagram showing example techniques by which a smart vehicle sends identification information to a fuel price-determination application.

FIG. 10 is a flow diagram showing example operation of a smartphone in a smart fueling system.

### DETAILED DESCRIPTION

### Overview

Techniques are described for configuring and operating a smart fueling system. An example illustrating some of the techniques discussed herein—not to be considered a full or comprehensive discussion—may assist the reader. The smart fueling system recognizes the identity and/or make/model of a vehicle and provides fuel at a price or rate (e.g., price per gallon or kilowatt hour) based on the efficiency of the vehicle (e.g., miles per gallon (MPG)). In an example, high MPG vehicles are charged less per gallon of fuel in an effort to change behavior of vehicle owners and drivers.

In an example, a smart fueling system includes a smart fueling station, which may be a gas pump or an entire service station. The fuel dispensed by the smart fueling station may be gasoline, diesel, natural gas, propane, hydrogen, electricity, battery swap-out, and/or other forms of energy. The smart fueling station may be equipped with any type of RF communications technologies, such near field communications (NFC), Bluetooth, Wi-Fi, and others, to communicate with a smart vehicle and/or a smartphone of a user, driver and/or vehicle owner. Using NFC, Bluetooth, or other technology, the smart fueling station determines the identity (e.g., make/model or vehicle identification number (VIN)) of a vehicle. The determination may be made by communicating with the vehicle and/or its on-board diagnostics port (e.g., OBDII port). Alternatively or additionally, the determination may be made by observation of the vehicle's size, shape or appearance, and/or the vehicle's license plate, by cameras and/or recognition software of the smart fueling station. The determination may alternatively be made by other means, such as communication with the driver's smartphone. In a further example, smart vehicle may include an on-board diagnostics port (e.g. an OBD II port). A modification to the on-board diagnostics, and/or a device attached to the port, may allow the vehicle to communicate by NFC with the smart fueling station or over the internet with a fuel price-determination application. The smart vehicle may be configured to communicate information regarding its identity to the smart fueling station and/or fuel price-determination application, thereby providing at least some of the information upon which a fuel price may be set.

The smart fueling station and/or vehicle may be in communication with a local or a remote server containing the fuel price-determination application. The fuel price-determination application associates a fuel price with the vehicle, based at least in part on one or more of the rated or measure fuel economy of the vehicle, the number of miles driven per unit time, and/or other factor(s). In a still further example, a smartphone of the driver may communicate information regarding the identity of the vehicle to the fuel price-determination application, which may assist in setting the fuel price.

### Example Systems and Techniques

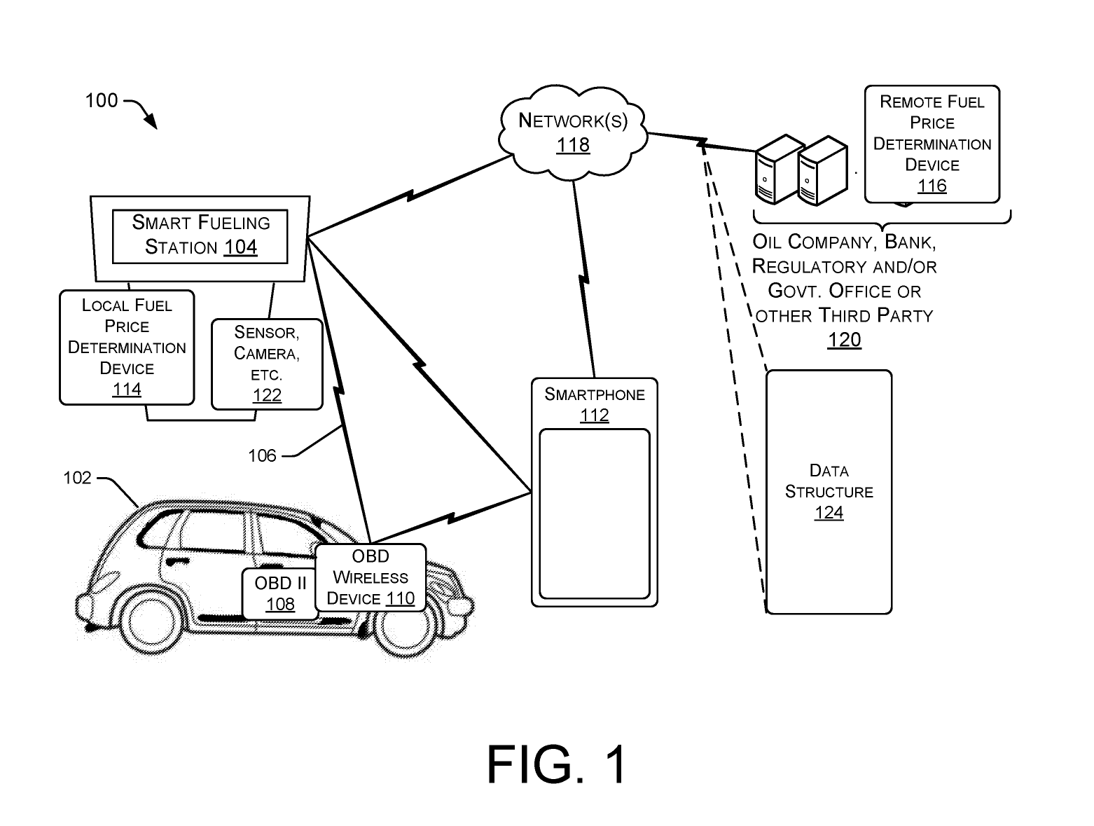

FIG. 1 shows an example system 100 configured to identify a vehicle 102 and/or characteristics of the vehicle and to set a fuel price to be charged when fueling the vehicle. The vehicle 102 may be powered by gasoline, diesel, electricity or other fuel. In the example shown, the vehicle 102 communicates with a smart fueling station 104, by radio frequency (RF) link 106, such as by operation of radios compatible with a Bluetooth or other radio standard. The vehicle 102 may include an on-board diagnostics port (e.g., OBD II) 108. In an example, an OBD wireless device 110 may be connected to the OBD II port 108, and may provide the RF link 106 to the smart fueling station 104. In a further example, the OBD wireless device 110 (and/or the vehicle 102 itself) may provide an RF link 126 to a smartphone of the driver and/or vehicle owner, to thereby exchange information with an application operating on the smartphone. In an example, the OBD wireless device 110 includes a processor and memory, and reads data from the OBD II port 108. The data may include a vehicle identification number (VIN), the odometer mileage reading, the make/model and/or other data associated with the vehicle 102. In one example, the OBD wireless device 110 is configured to operate (e.g., on an internal rechargeable battery), allowing it to operate when the vehicle 102 is turned off. In the example, when the vehicle 102 is turned off, it may have been turned off adjacent to a smart fueling station. Accordingly, the OBD wireless device 110 may assume that a smart fueling station may be available, and attempt to communicate with that station. Alternatively, or additionally, the OBD wireless device 110 may attempt to communicate with the user/driver's smartphone. The smartphone may serve as a relay, for the OBD wireless device 110 to communicate with the smart fueling station 104. The smartphone may use either wireless protocols (e.g., Bluetooth) or the internet to communicate with the smart fueling station. When the connection is made, the OBD wireless device 110 provides information to the smart fueling station 104 that allows the station to identify the vehicle.

The smart fueling station 104 may be or include one “gas pump,” or may be or include an entire “service station.” The fuel may include gasoline, diesel, electricity, replacement (swap-out) batteries, and/or other fueling technologies. The smart fueling station 104 may include a Bluetooth or other wireless device and/or an internet connection to communicate with the OBD wireless device 110 or a smartphone 112 owned by the driver of the car 102.

The smart fueling station 104 may receive data from a variety of sources, such the vehicle 102 (e.g., the OBD wireless device 110 of the vehicle) or a smartphone 112 of the driver. The received data may be used to identify the vehicle 102 and/or characteristics of the vehicle. Such an identification may be used to determine a fuel rate (i.e., the fuel price). In some cases, the actual identification of the vehicle, such as by VIN number, is required. In other cases, only a general idea of the characteristics of the vehicle (e.g., make/model, vehicle weight, engine displacement, EPA fuel mileage rating, etc.) is required.

The price of the fuel dispensed by the smart fueling station 104 may be set by local or remote action. Failing action, a default price may be set, which is typically greater than or equal to a price set by an action of an application. In two examples, the fuel price may be set by a local fuel price-determination application 114 or by a remote fuel price-determination application 116.

The local fuel price-determination application 114 may be configured to set the fuel price. The local fuel price-determination application 114 may be a software program or application running on a processor and memory of the smart fueling station 104. The local fuel price-determination application 114 may receive updates over a network (e.g., the internet 118) from the remote fuel price-determination application 116, which may be located at an oil company, bank, regulatory agency or other government office and/or other third party 120.

The remote fuel price-determination application 116 may determine prices for one or more smart fueling stations, and may be located and/or operable within a server at any location, such as an oil and/or energy company, bank, regulatory or government agency, or other third party 120. In an example, fuel price-determination (i.e., rate-setting) may be based on federal, state and/or local governments. In such examples, each governmental layer may enforce and collect a charge per gallon or as a percentage. In other examples, portions of the fuel price-determination, enforcement and collection may be performed by energy companies, banks and/or fueling stations.

Singly or in combination, the local fuel price-determination application 114 and/or the remote fuel price-determination application 116 may be configured to calculate the price of fuel for any particular customer. The calculation may be based on a plurality of factors or inputs, such as the fuel economy of the car of the customer, the number of miles per year driven, the location of the fuel station, the number of passengers typically or actually in the car, and/or other factors. The calculation may be based at least in part on market forces, governmental policy, and/or other factors.

The price paid for the fuel may be divided among one or more entities, including the fuel station, a fuel supply company (e.g., an oil company or electric company, for fueled or electric cars, respectively), a bank (e.g., for credit card or payment services), federal, state and/or local taxing authorities, and/or a third-party provider and/or manager of the fuel price-determination application. In an example, one or more of the above-listed entities may receive a percentage or other portion of the price paid by the motorist.

The revenue provided to any of the entities may be determined by market forces, legislation and/or other factors. In an example, the manager of the fuel price-determination application may receive a fee or percentage based on government policy. Alternatively, the fee or percentage may result from an award of a contract involving one or more governmental agencies and/or corporations. In the example, the third-party provider and/or manager of the fuel price-determination application(s) is provided with a percentage of the money paid for fuel in exchange for providing, maintaining and/or managing the local and/or remote fuel price-determination applications 114, 116. In the example, the manager would provide updates to the application so that it was well-adapted to price fuel for newly-marketed vehicles, changes in a particular vehicle's driving characteristics (e.g., adherence to speed limits, miles per year, etc.), changes in the price of fuel, changes in tax levels, etc.

In operation, either fuel price-determination application 114, 116 may receive a request for a fuel price with respect to a particular vehicle (e.g., as indicated by VIN) or a vehicle of a particular type (e.g., as indicated by make, model and/or option packages). The applications 114, 116 may be configured to follow an algorithm that is set by governmental legislation, wherein the price of fuel is set based on fuel economy of the automobile being fueled, miles driven by the vehicle and/or driver per unit time (e.g., year), availability of public transportation alternatives, local costs (e.g., local real estate costs, taxes, labor rates, etc.), and/or other factors.

One or more sensor, camera, or other input device 122 may be available to the smart fueling station 104. The camera, sensor or other input device may provide information that may be used to determine and/or confirm the identity and/or type of the vehicle 102. In one example, the vehicle provides VIN, make/model information and/or EPA fuel economy rating information to the smart fuel station. In the example, the smart fueling station 104 attempts to confirm some or all of the information, such as to prevent fraud. The smart fueling station 104 may use a camera 122 to obtain an image of the license plate of the vehicle 102. The vehicle license may be used to determine make, model and other aspects of the vehicle 102. This information may be used to confirm the veracity of information collected from the OBD wireless device 110 of the vehicle and/or the driver's smartphone. Similarly, an image of the vehicle may assist to confirm or reject information obtained from the vehicle and/or smartphone 112. Additionally, a scale can determine if the weight of the vehicle is consistent with the vehicle type reported by the OBD wireless device 110 and/or smartphone. This confirming information may also be used as an input to determine the price of fuel for the vehicle.

Data may be sent from the fueling station 104 to the energy company, bank, etc. 120 during and/or after the fueling transaction. The data may be configured within a data structure 124, and may include one or more of the date and time of the fueling transaction, the vehicle identification, make, model, VIN, owner's name, driver's, the name on the credit card or smartphone payment, the location of fueling station, and/or other data. The information may be used for a number of purposes, such as fuel cost determination, payment purposes, driving statistics, fraud recognition and prevention, traffic studies, and/or other purposes.

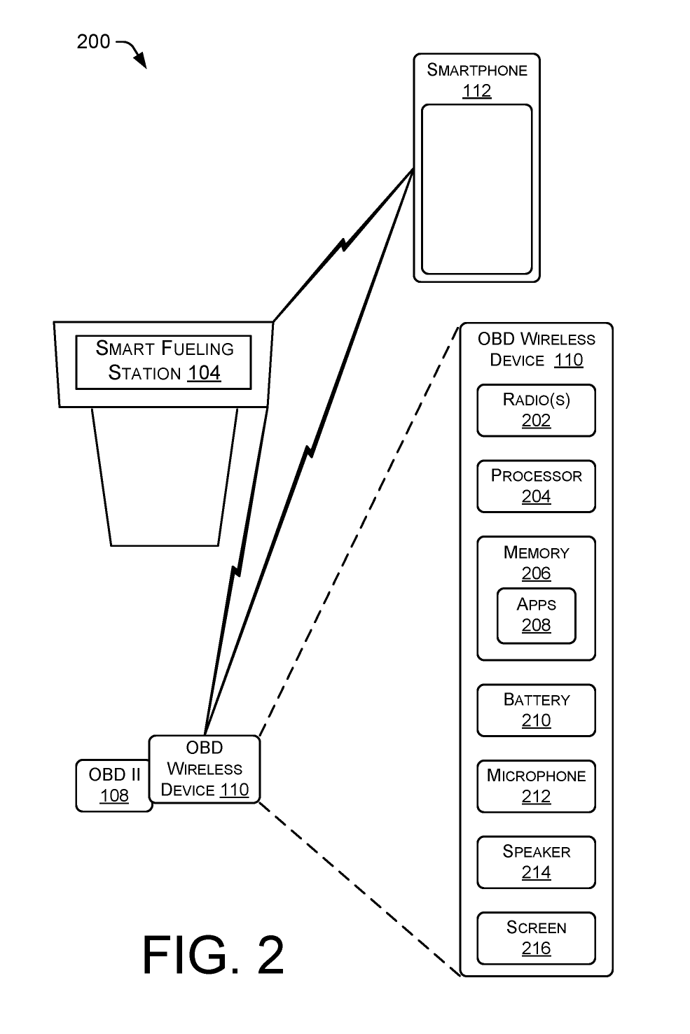

FIG. 2 shows example an example environment 200, including the example of the OBD wireless (e.g., on-board diagnostics and Bluetooth RF compatible) device 110. In the example shown, the OBD wireless device 110 is configured for attachment to the on-board diagnostics port 108 of a vehicle. In the example, the OBD wireless device 110 is configured with one or more radios 202. Example radios include a Bluetooth- or other technology-based radio to communicate with the smart fueling station 104 and/or the smartphone 112. The radio 202 may alternatively or additionally be configured to for longer range communication, such as using a cellular service to communicate with the internet. A processor 204 and memory 206 may be configured to run an operating system and one or more software applications 208. The applications 208 may interrogate the OBDII 108, operate the radio 202, communicate with the smart fueling station 104 and/or smartphone 112, and communicate with the local and/or remote fuel price-determination applications 114, 116. A battery 210 may be used so that the OBD wireless device 110 can operate even after the vehicle has been turned off. In an example, when the vehicle is turned off, there is a chance that it was turned off next to a smart fuel pump to allow refueling. The OBD wireless device 110 can then attempt to establish communication with the smart fueling station 104 or the driver's smartphone using power from the battery 208.

In the example shown, the OBD wireless device 110 provides a user interface including a microphone 212, a speaker 214 and a screen or touch screen 216. The user interface allows the user/driver to provide any input that assists in securing an appropriate fuel price. The user interface also provides confirmation of the price received, and may also allow the user/driver to utilize a payment method. In some instances, the user interface may utilize the microphone, speaker and/or touch screen of the user/driver's smartphone.

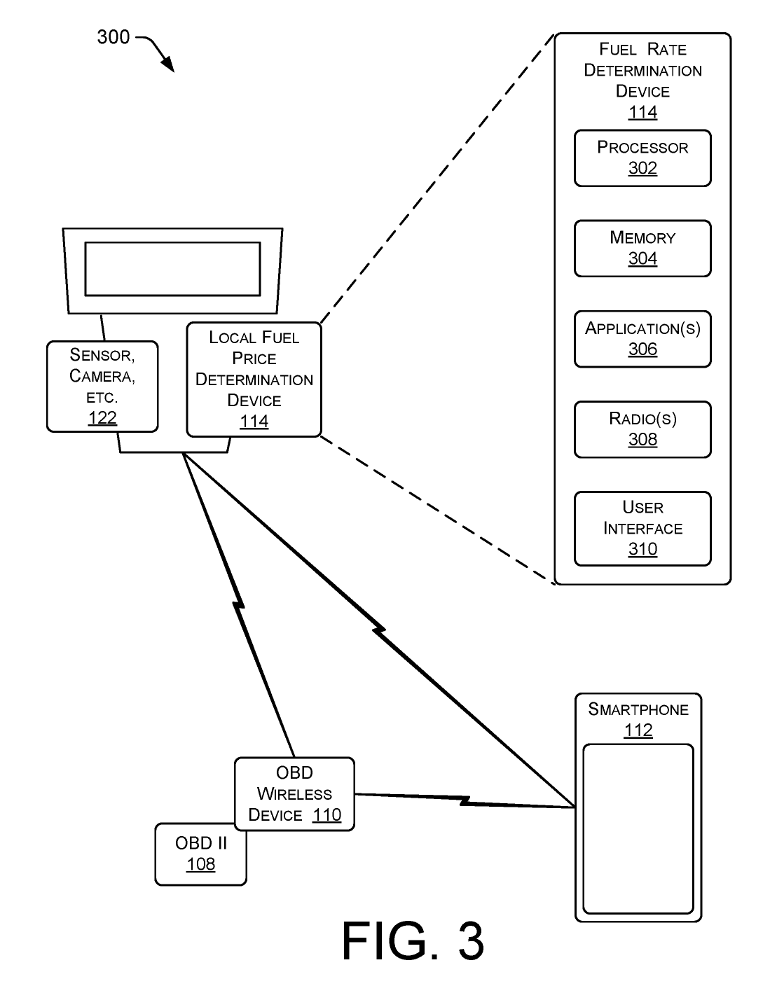

FIG. 3 shows example an example environment 300, showing an example of the of the fuel price-determination device 114. Characteristics of the device 114 are adaptable for use with the remote fuel price-determination device 116. A processor 302 and memory 304 are configured to run an operating system and one or more application(s) 306. The applications 306 may be configured to obtain identification information from a vehicle, such as by interrogation of the OBD wireless device 110. The interrogation may be performed over an RF link (e.g., a Bluetooth link), by operation of one or more radios 308. The applications 306 may be configured to determine a fuel prices, based at least in part on the identification of the vehicle, and/or the characteristics of the vehicle. The applications 306 may also be configured to operate the camera and sensors 122, and to gather data that confirms, or indicates error or fraud, in the identification of the vehicle or vehicle type. Generally, more fuel-efficient vehicles, particularly those being driven less miles per month and/or in areas that are less served by public transportation, are awarded lower fuel prices than other vehicles. A user interface 310 may include a screen or touch screen, camera, speaker(s) and microphone(s). The user interface 310 may allow the driver of the vehicle to input information, such as the user's name, the vehicles license plate number, driver's license or credit card (e.g., hold up, to be photographed), etc.

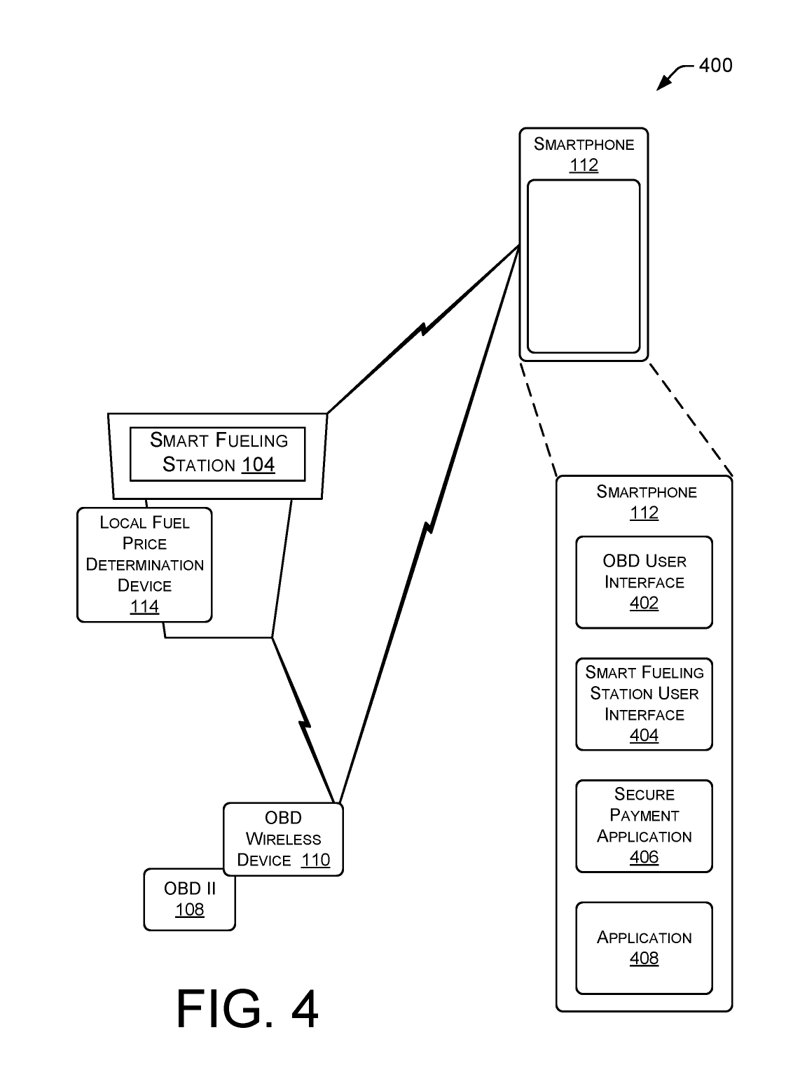

FIG. 4 shows example detail of a smartphone 112 for use in an example system 400 configured for vehicle identification and sale of fuel at variable rates. In one embodiment, the smartphone 112 provides one or more user interfaces to allow the driver to communicate with one or more of the OBD wireless device 110, the smart fueling station 104 and a remote bank, credit card or other financial institution 120 (as shown in FIG. 1). The user interfaces may be separate or combined, and allow the driver to conveniently adjust settings of the OBD wireless device 110, determine fuel costs, and/or pay for the fuel. The smartphone 112 is easily within reach of the user/driver, and provides touch screen, microphone and speakers. While a smartphone is shown, a communications device integrated with the vehicle or the OBD wireless device 110 is also considered to be a “smartphone” for purposes of this discussion.

The OBD user interface 402 allows the user to communicate with the OBD wireless device 110. In an example, the user interface allows the user to authorize the OBD wireless device 110 to communicate with the smart fueling station 104 through the smartphone 112. The smartphone 112 may provide a radio link between the OBD wireless device 110 and the smart fueling station 104. In an example, the smartphone 112 may have a wireless link (e.g., Bluetooth or other technology) with the OBD wireless device 110, and may then connect in a secure manner (e.g., https) over the internet to the smart fueling station.

The smart fueling station user interface 404 allows the driver to communicate with the smart fueling station 104. The driver may enter information, if required, and may receive information, such as the fuel price. In many configurations, the OBD wireless device 110 or an application 408 will provide any required information for the driver. In an example, the application 408 may be pre-configured (either at the smartphone 112 or in a remote server in communication with the application 408) with information regarding the driver. The information may include user/driver identification, credit card information, banking information, store coupons, gift cards, credits, offers/advertisements purchase history and/or other information as indicated by particular systems.

The secure payment interface 406 allows the driver to make secure payment for the fuel. Typically, the fuel quantity, price per unit and total cost is shown, and the driver is asked to approve. Secure payment may be made, from the smartphone to the smart fueling station, using either NFC or the internet (e.g., https).

### Example Methods

In some examples of the techniques discusses herein, the methods of operation may be performed by one or more application specific integrated circuits (ASIC) or may be performed by a general-purpose processor utilizing software defined in computer readable media. In the examples and techniques discussed herein, the memory of the OBD wireless device 110, the smart fueling station 104 and/or the smartphone 112 may comprise computer-readable media and may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media does not include transitory media, such as modulated data signals and carrier waves, and/or signals.

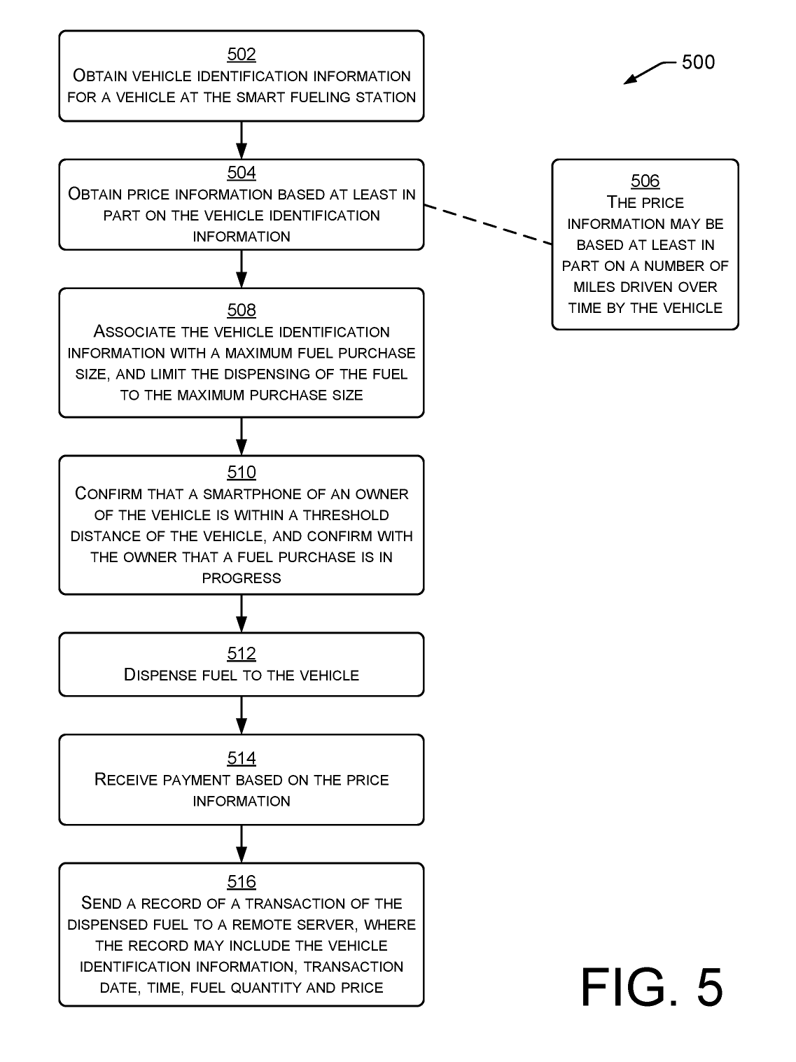

FIG. 5 is a flow diagram showing example operation 500 of a smart fueling station in a smart fueling system. In an example, the smart fueling station obtains vehicle identification information of a vehicle at the smart fueling station. The vehicle identification information may be make/model, a VIN number, or other identifier. The vehicle identification information may be obtained by the smart fueling station from the vehicle, such as from the vehicle's on-board diagnostic port (e.g., OBD II port), or may be obtained from the driver's smartphone, or from another device. Using the vehicle identification information, the smart fueling station obtains fuel price information. The price information may be generated by application(s) operating on the smart fueling station, or remote applications accessed over the internet. In an example, the fuel price may be lower for more fuel-efficient vehicles, and higher for less fuel-efficient vehicles. When a fuel price is set, fuel is dispensed into the vehicle. The driver may make payment using any desired means, such as credit card or electronic payment (e.g., by smartphone) over a radio frequency (RF)—possibly near field communication (NFC)—link.

At block 502, the smart fueling station obtains vehicle identification information from the vehicle, vehicle's OBDII port, the driver, the driver's smartphone or another source. The smart fueling station may be a single fuel pump or a multiple-bay service station and/or fueling facility. In the example of FIG. 1, the smart fueling station 104 obtains vehicle identification information from the adjacent vehicle 102 (e.g., vehicle within reach of a fueling hose (or cable, in the case of electrically powered vehicles)).

At block 504, the smart fueling station obtains fuel price information (i.e., a fuel price). The fuel price may be based at least in part on the vehicle identification information. In an example, different makes and models of cars, and in some cases, different drive train options, may have different fuel prices. Block 506 shows a further example, wherein the fuel price may be based at least in part on a number of miles driven by the vehicle per unit time (e.g., the number of miles driven in the last year). In this example, vehicles that are driven more miles may pay a higher price for fuel.

At block 508, the smart fueling station uses the vehicle identification information to associate the vehicle with a maximum fuel purchase size. In an example, the vehicle may be prevented from purchasing more fuel than will fit in its empty fuel tank. This prevents first and second vehicles from fueling at a price that is associated only with the first vehicle. Accordingly, the smart fueling station limits the purchase to the maximum purchase size and/or a time between purchases. In a further example, a rate (e.g., gallons per week or other period of time) may be monitored, and different thresholds may be enforced, such as maximum allowed fuel quantity and/or fuel purchases per day, week, month, etc.

At block 510, the smart fueling station may confirm that a smartphone of an owner of the vehicle is within a threshold distance of the vehicle. This information may be obtained from the smartphone provider, or directly from the smartphone itself, such as through NFC communication. Additionally or alternatively, the smart fueling station may confirm with the smartphone owner (vehicle driver) that a fuel purchase is in progress. Thus, if a bad actor is pretending to be the smartphone owner (to get the beneficial fuel rate of the owner) the smartphone owner will have a chance to report this fact.

At block 512, the smart fueling station dispenses the fuel into the vehicle. At block 514, the smart fueling station receives payment based on the price information and the quantity of fuel dispensed. The payment may be made by credit card, electronic funds transfer over NFC, or other means. At block 516 the smart fueling station sends a record of a transaction of the dispensed fuel to the vehicle. The record may be sent to a remote server, such as at a regulatory agency, energy company, financial institution and/or other location. The record may include the vehicle identification information, date, time, fuel quantity, price and/or other information. In an example, the smartphone 112 and an application operating on the smartphone (e.g., the payment application 406) may maintain a log of fuel transactions, including date, location, price, quantity, etc. The log may alternatively or additionally be maintained by one or more of the third-party entities 120.

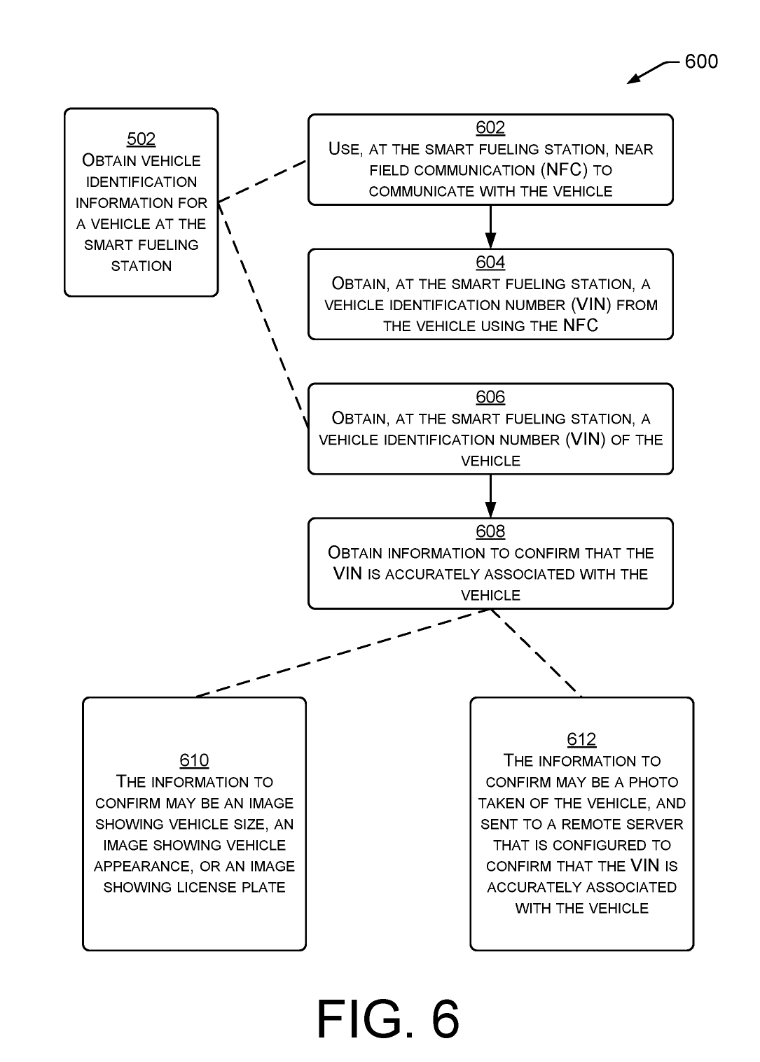

FIG. 6 shows example techniques 600 by which a smart fueling station can obtain vehicle identification information, and accordingly, example techniques by which block 502 of FIG. 5 may be performed. At block 602, the smart fueling station uses wireless RF (e.g., Bluetooth or other technology) to communicate with a vehicle. In an example, the vehicle may be located at a fuel pump, and may communicate with the smart fueling station. At block 604, the smart fueling station obtains a vehicle identification number (VIN) of the vehicle. In the example of FIG. 1, the smart fueling station obtains the VIN from the OBD wireless device 110 of the vehicle. Alternatively, the smart fueling station may obtain the VIN from the driver's smartphone, particularly if the VIN can be confirmed as authentic by cryptographic means.

At block 606, additional example techniques by which a smart fueling station can obtain vehicle identification information are described. At block 606, the smart fueling station obtains a VIN number of the vehicle. At block 608, the VIN is confirmed to be accurately associated with the vehicle. The confirmation protects against fraud, which may be motivated by the multiple prices charged for fuel, i.e., by spoofing the smart fueling station with an incorrect VIN, a bad actor may be able to obtain a lower price. A number of techniques may be used to confirm information about the vehicle, examples of which are shown in blocks 610 and 612. At block 610, the information used to confirm the VIN (or other vehicle identification, such as make/model) may be an image showing vehicle size, and image showing vehicle appearance, or an image showing a license plate of the vehicle. At block 612, the information used to confirm the vehicle identification may be a photo taken of the vehicle, and sent to a remote server that is configured to confirm (e.g., by photo recognition technology) that the vehicle identification is accurately associated with the vehicle.

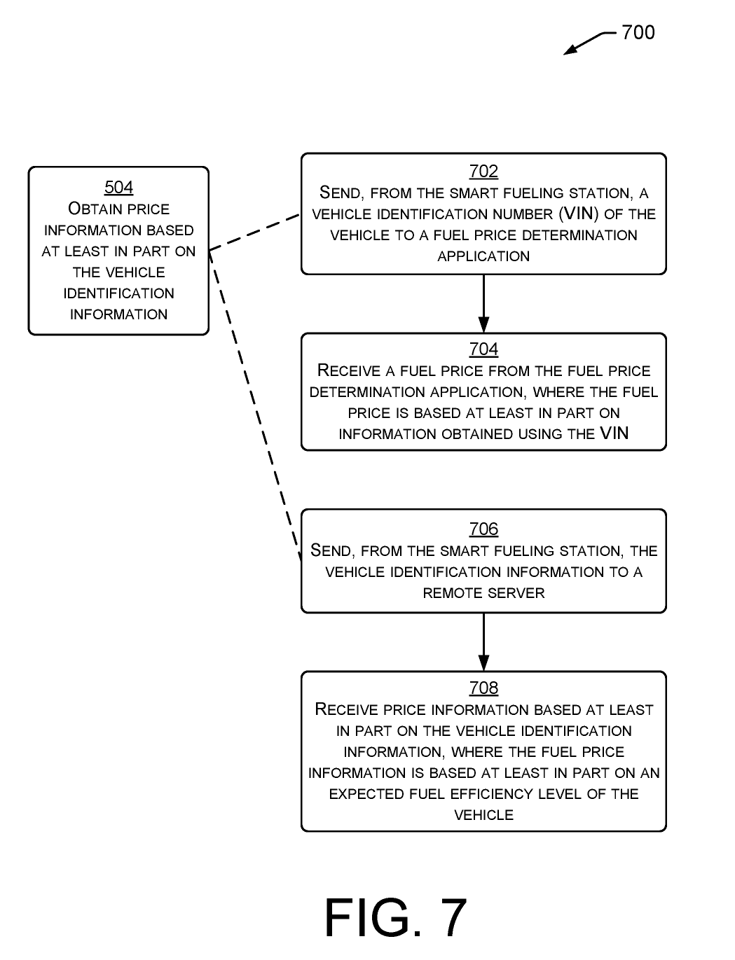

FIG. 7 shows example techniques 700 by which a smart fueling station can obtain price information specific to the vehicle, and accordingly, example techniques by which block 504 of FIG. 5 may be performed. In different examples of systems performing techniques that obtaining price info, the techniques could be locally and/or remotely executed. FIG. 1 shows both a local example of price-determination (i.e., local fuel price-determination device 114) and a remote example of price-determination (i.e., remote fuel price-determination device 116, which may be operable on one or more of the third-party entities 120). Local price-determination applications and/or devices could be utilized if the internet connection is lost at the smart fueling station or other price-determining entity.

At block 702, the smart fueling station sends a VIN of the vehicle to a fuel price-determination application. At block 704, the smart fueling station receives a fuel price from the fuel price-determination application. In an example, the fuel price is based at least in part on information obtained using the VIN. For example, the VIN may be used to access a database, which correlates VIN, make, model, fuel price and/or discount rate, and/or other factors.

At block 706, additional example techniques by which a smart fueling station can obtain price information for a vehicle are described. At block 706, the smart fueling station sends the vehicle identification information to a server. At block 708, the smart fueling station receives price information based at least in part on the vehicle identification information. The received fuel price information may be correlated to an expected fuel efficiency level of the vehicle (e.g., the vehicle's miles per gallon (mpg)).

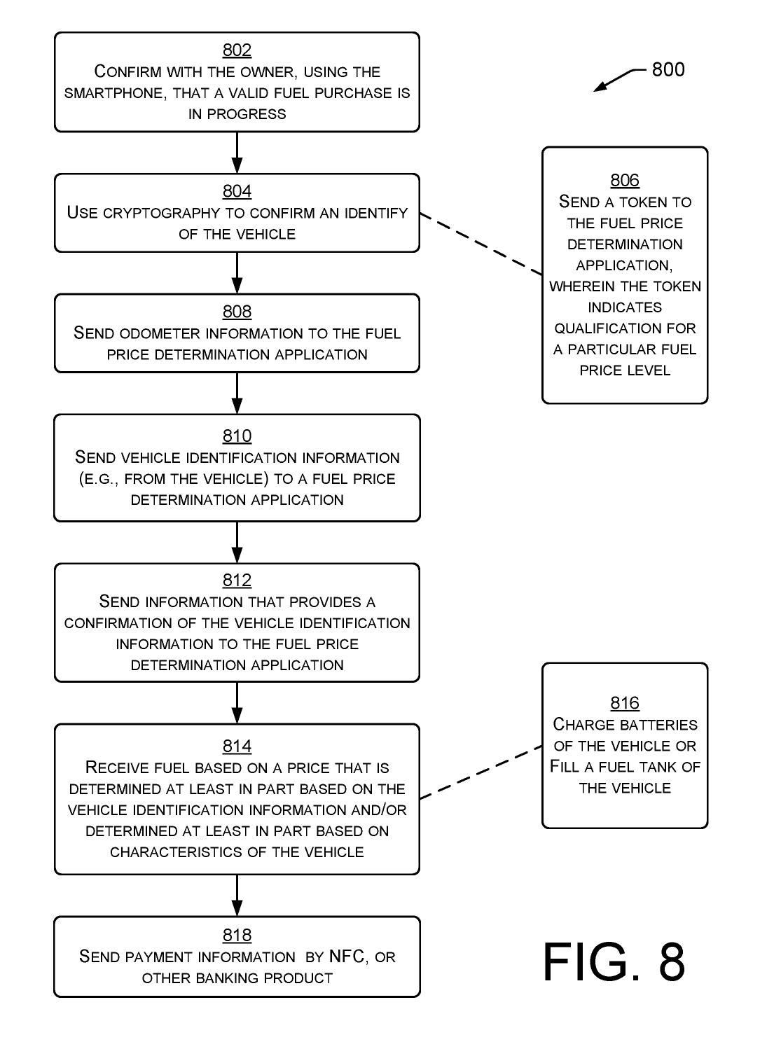

FIG. 8 shows example operational techniques 800 of a smart vehicle in a smart fueling system. At block 802, the smart vehicle confirms with the driver/owner, such as by use of the driver's smartphone, that a fuel purchase is in progress. Such a confirmation helps to reduce fraud, where a bad actor may try to buy fuel at a lower price by masquerading as the owner of a more fuel-efficient vehicle. At block 804, the smart vehicle uses cryptography to confirm the identity of the smart vehicle. In an example, a private key of the vehicle is able to decode a message sent encoded by a public key of the vehicle, in a manner that allows the vehicle to prove its identity to the smart fueling station. At block 806, the smart vehicle sends a token to the fuel price-determination application. The token may be configured to indicate qualification for a particular fuel price, price level, discount, etc.

At block 808, the smart vehicle sends odometer information to the price-determination application. The odometer reading may indicate, or allow calculation of, miles driven over one or more different time periods. In a first example, if the miles driven since the last fill up do not indicate that fuel is needed, this may indicate that fraud is involved. In a second example, if the miles driven over the last year are low, this may indicate that a fuel price discount should be made available to the vehicle.

At block 810, the smart vehicle sends vehicle identification information to a fuel price-determination application. The vehicle identification information may be obtained from the OBD II port device 108 of FIG. 1, or by other means. At block 812, the smart vehicle sends information that provides a confirmation of the vehicle identification information to the fuel price-determination application. The confirmation may include a token, encrypted data, or other information. Alternatively, the smart fueling station may send the confirmation information to the fuel price-determination application. The confirmation information may include a photograph of the smart vehicle, the vehicle's license plate, or other data.

At block 814, the smart vehicle receives fuel based on a price that is determined at least in part based on the vehicle identification information and/or determined at least in part based on characteristics of the vehicle. The characteristics may include make, model, miles in past year, etc. At block 816, the received fuel may fill a gasoline, diesel, natural gas tanks, or may recharge or swap-out batteries of the vehicle.

At block 818, the smart car may send payment information by NFC, or by credit card or other banking product.

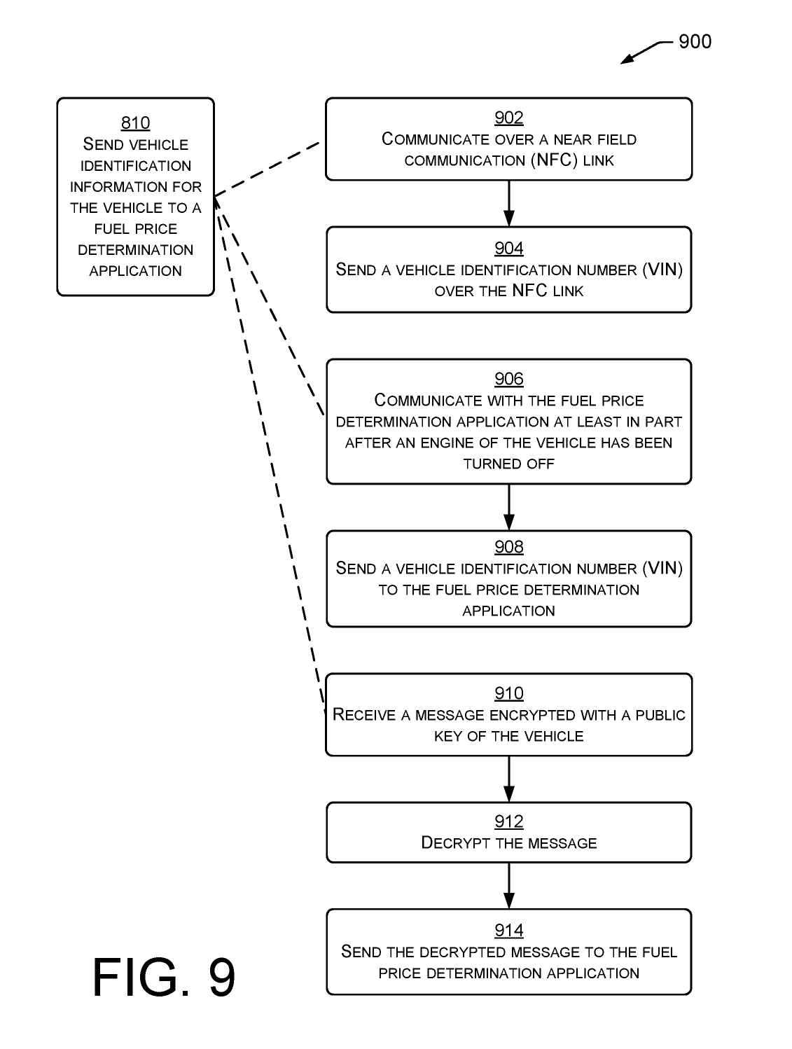

FIG. 9 shows example techniques 900 by which a smart vehicle sends identification information to a fuel price-determination application, and accordingly, example techniques by which block 810 of FIG. 8 may be performed. At block 902, the smart vehicle communicates over a NFC link, and at block 904 sends a VIN number over that link.

In an example at block 906, the smart vehicle communicates with the fuel price-determination application at least in part after an engine of the vehicle has been turned off. Referring to FIGS. 1 and 2, the OBD wireless device 110 may be battery powered, and may wake up when the vehicle is turned off, to determine if the vehicle has parked next to a smart fuel station. At block 908, the smart vehicle sends a VIN number to the fuel price-determination application, directly or indirectly through a smartphone or another intermediary.

In an example at block 910, the smart vehicle receives a message encrypted with the public key of the vehicle. At block 912, the smart vehicle decrypts the message with its private key. At block 914, the smart vehicle sends the decrypted message to the fuel price-determination application, thereby proving it identity. Accordingly, the smart vehicle is able to reduce fraud by providing proof of its identity, to supplement the assertion that the supplied VIN number is correct.

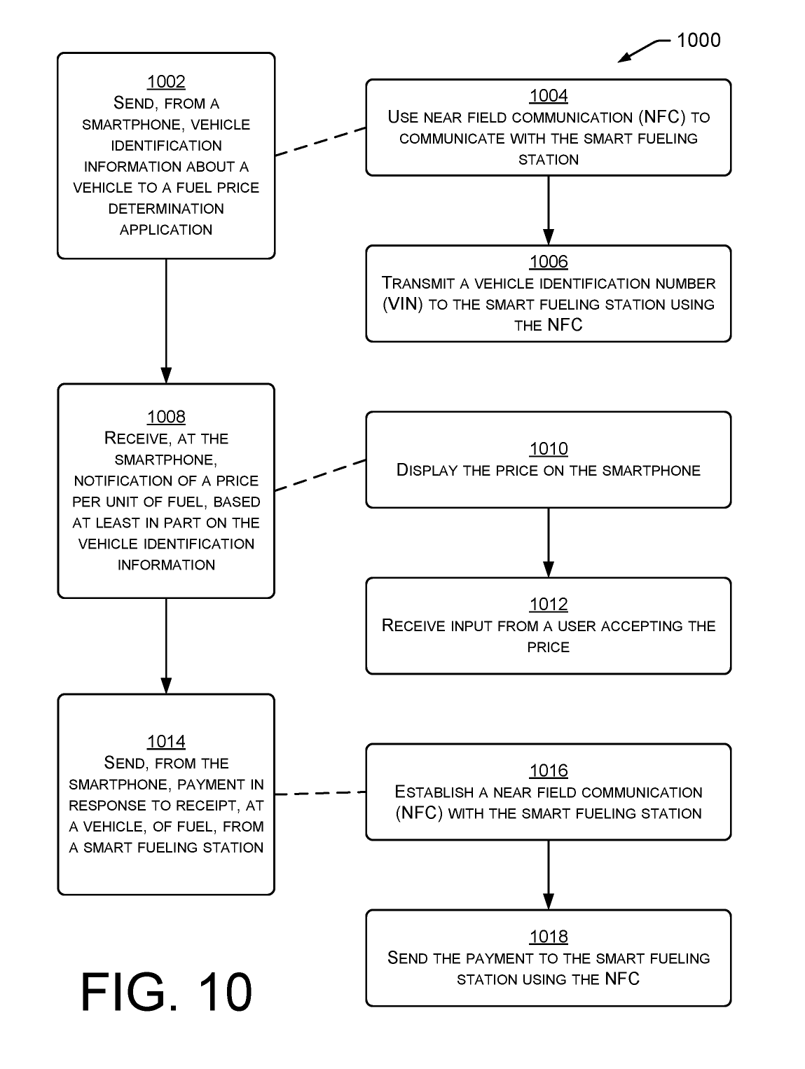

FIG. 10 shows example operating techniques 1000 of a smartphone and/or smartphone application in a smart fueling system. At block 1002, a smartphone application sends vehicle identification information about a vehicle fuel price-determination application. Blocks 1004 and 1006 show examples of this action. In the example of block 1004, the smartphone uses NFC or the internet to communicate with the smart fueling station. At block 1006, the smartphone transmits a VIN to the smart fueling station using NFC, the internet or other network or RF link.

At block 1008, the smartphone application receives notification of a price per unit of fuel, based at least in part on the vehicle identification information. Blocks 1010 and 1012 show examples of this action. In the example of block 1010, the pricing information is displayed on a screen of the smartphone. At block 1012, the smartphone application receives input from the user (e.g., the driver of the vehicle) indicating acceptance of the price.

At block 1014, the smartphone application sends payment in response to receipt, at the vehicle, of fuel from the smart fueling station. Blocks 1016 and 1018 show examples of this action. In the example of block 1016, the smartphone and/or smartphone application establishes an NFC, internet or other network connection with the smart fueling station, bank or another payment agent (bank, energy company, etc.). At block 1018, payment is sent over the established connection.

A first example method of operating a smart fueling station, comprises: obtaining vehicle identification information for a vehicle at the smart fueling station; obtaining price information based at least in part on the vehicle identification information; dispensing fuel to the vehicle; and receiving payment for the dispensed fuel based on the price information. In the first example method, obtaining vehicle identification information may comprise: using, at the smart fueling station, a radio frequency (RF) device to communicate with the vehicle; and obtaining, at the smart fueling station, a vehicle identification number (VIN) from the vehicle, using the RF device. In the first example method, obtaining vehicle identification information may comprise: obtaining, at the smart fueling station, a vehicle identification number (VIN) of the vehicle; and obtaining information to confirm that the VIN is accurately associated with the vehicle. In the first example method, the information may be at least one of: an image showing vehicle size; an image showing vehicle appearance; and an image showing a license plate. In the first example method, the information to confirm may comprise: capturing an image of the vehicle; and sending the image to a remote server that is configured to confirm that the VIN is accurately associated with the vehicle. In the first example method, obtaining price information may comprise: sending, from the smart fueling station, a vehicle identification number (VIN) of the vehicle to a fuel price-determination application; and receiving a fuel price from the fuel price-determination application, wherein the fuel price is based at least in part on information obtained using the VIN. In the first example method, obtaining price information may comprise: sending, from the smart fueling station, the vehicle identification information to a server; and receiving fuel price information based at least in part on the vehicle identification information, wherein the fuel price information is correlated to an expected fuel efficiency level of the vehicle. The first example method may additionally comprise: sending a record of a transaction of the dispensed fuel to a remote server; and the record may comprise: the vehicle identification information; and date, time, fuel quantity and price associated with the transaction. The first example method may additionally comprise: confirming that a smartphone of an owner of the vehicle is within a threshold distance of the vehicle; and confirming with the owner of the vehicle that a fuel purchase is in progress. The first example method may additionally comprise: associating the vehicle identification information with a maximum purchase size; and limiting the dispensing of the fuel to the maximum purchase size. In the first example method, the price information may be based at least in part on a number of miles driven over a period of time by the vehicle.

A second example method, operable by a vehicle and to obtain fuel, comprises: sending vehicle identification information of the vehicle to a fuel price-determination application; sending information that provides a confirmation of the vehicle identification information to the fuel price-determination application; and receiving fuel based on a price that is: determined at least in part based on the vehicle identification information; and determined at least in part based on characteristics of the vehicle. In the second example method, sending vehicle identification information may comprise: communicating over a radio frequency (RF) link; and sending a vehicle identification number (VIN) over the RF link. In the second example method, sending the vehicle identification information may comprise: communicating with the fuel price-determination application at least in part after an engine of the vehicle has been turned off; and sending a vehicle identification number (VIN) to the fuel price-determination application. In the second example method, sending information that provides the confirmation may comprise: receiving a message encrypted with a public key of the vehicle; decrypting the message; and sending the decrypted message to the fuel price-determination application. The second example method, may additionally comprising: using cryptography to confirm an identify of the vehicle. In the second example method, receiving fuel may comprise: charging batteries of the vehicle; or filling a fuel tank of the vehicle. The second example method may additionally comprise: confirming that a smartphone of an owner of the vehicle is in near field communication (NFC) with a smart fueling station; and confirming with the owner, using the smartphone, that a valid fuel purchase is in progress. The second example method may additionally comprise: sending payment information by NFC; or sending payment information by credit card. The second example method may additionally comprise: sending odometer information to the fuel price-determination application. The second example method may additionally comprise: sending a token to the fuel price-determination application, wherein the token indicates qualification for a particular fuel price level.

A third example method, comprises: sending, from a smartphone, vehicle identification information about a vehicle, to a fuel price-determination application; receiving, at the smartphone, notification of a price per unit of fuel, based at least in part on the vehicle identification information; and sending, from the smartphone, payment in response to receipt, at a vehicle, of fuel, from a smart fueling station. In the third example method, sending vehicle identification information may comprise: using wireless communication to communicate with the smart fueling station; and transmitting a vehicle identification number (VIN) to the smart fueling station using the wireless communication. In the third example method, receiving notification of the price per unit of fuel may comprise: displaying the price on the smartphone; and receiving input from a user accepting the price. In the third example method, sending payment may comprise: establishing a near field communication (NFC) with the smart fueling station; and sending the payment to the smart fueling station using the NFC. The third example method may additionally comprise: confirming that the smartphone of an owner of the vehicle is within a threshold distance of the smart fueling station; and confirming with the owner, using the smartphone, that a fuel purchase is in progress.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of operating a smart fueling station, comprising:
obtaining vehicle identification information for a vehicle at the smart fueling station;
obtaining price information based at least in part on the vehicle identification information;
dispensing fuel to the vehicle; and
receiving payment for the dispensed fuel based on the price information.

2. The method of claim 1, wherein obtaining vehicle identification information comprises:
using, at the smart fueling station, a radio frequency (RF) device to communicate with the vehicle; and
obtaining, at the smart fueling station, a vehicle identification number (VIN) from the vehicle, using the RF device.

3. The method of claim 1, wherein obtaining vehicle identification information comprises:
obtaining, at the smart fueling station, a vehicle identification number (VIN) of the vehicle; and
obtaining information to confirm that the VIN is accurately associated with the vehicle.

4. The method of claim 1, wherein obtaining price information comprises:
sending, from the smart fueling station, the vehicle identification information to a server; and
receiving fuel price information based at least in part on the vehicle identification information, wherein the fuel price information is correlated to an expected fuel efficiency level of the vehicle.

5. The method of claim 1, additionally comprising:
sending a record of a transaction of the dispensed fuel to a remote server;
wherein the record comprises:
the vehicle identification information; and
date, time, fuel quantity and price associated with the transaction.

6. The method of claim 1, additionally comprising:
confirming that a smartphone of an owner of the vehicle is within a threshold distance of the vehicle; and
confirming with the owner of the vehicle that a fuel purchase is in progress.

7. The method of claim 1, additionally comprising:
associating the vehicle identification information with a maximum purchase size; and
limiting the dispensing of the fuel to the maximum purchase size.

8. The method of claim 1, wherein:
the price information is based at least in part on a number of miles driven over a period of time by the vehicle.

9. A method, operable by a vehicle, to obtain fuel, comprising:
sending vehicle identification information of the vehicle to a fuel price-determination application;
sending information that provides a confirmation of the vehicle identification information to the fuel price-determination application; and
receiving fuel based on a price that is:
determined at least in part based on the vehicle identification information; and
determined at least in part based on characteristics of the vehicle.

10. The method of claim 9, wherein sending the vehicle identification information comprises:
communicating with the fuel price-determination application at least in part after an engine of the vehicle has been turned off; and
sending a vehicle identification number (VIN) to the fuel price-determination application.

11. The method of claim 9, wherein sending information that provides the confirmation comprises:
receiving a message encrypted with a public key of the vehicle;
decrypting the message; and
sending the decrypted message to the fuel price-determination application.

12. The method of claim 9, additionally comprising:
using cryptography to confirm an identify of the vehicle.

13. The method of claim 9, wherein receiving fuel comprises:
charging batteries of the vehicle; or
filling a fuel tank of the vehicle.

14. The method of claim 9, additionally comprising:
confirming that a smartphone of an owner of the vehicle is in near field communication (NFC) with a smart fueling station; and
confirming with the owner, using the smartphone, that a valid fuel purchase is in progress.

15. The method of claim 9, additionally comprising:
sending odometer information to the fuel price-determination application.

16. The method of claim 9, additionally comprising:
sending a token to the fuel price-determination application, wherein the token indicates qualification for a particular fuel price level.

17. A method, comprising:
sending, from a smartphone, vehicle identification information about a vehicle, to a fuel price-determination application;
receiving, at the smartphone, notification of a price per unit of fuel, based at least in part on the vehicle identification information; and
sending, from the smartphone, payment in response to receipt, at a vehicle, of fuel, from a smart fueling station.

18. The method of claim 17, wherein sending vehicle identification information comprises:
using wireless communication to communicate with the smart fueling station; and
transmitting a vehicle identification number (VIN) to the smart fueling station using the wireless communication.

19. The method of claim 17, wherein receiving notification of the price per unit of fuel comprises:
displaying the price on the smartphone; and
receiving input from a user accepting the price.

20. The method of claim 17, additionally comprising:
confirming that the smartphone of an owner of the vehicle is within a threshold distance of the smart fueling station; and
confirming with the owner, using the smartphone, that a fuel purchase is in progress.
